(19) United States
(12) Patent Application Publication
(10) Pub. No.: US 2002/0098308 A1
(43) Pub. Date: Jul. 25, 2002

(54) LOW MOLECULAR WEIGHT POLYMERS AND THEIR USE AS DISPERSION AIDS

(76) Inventors: FRANK C. CESARE, WOODBURY, CT (US); KAREN A. LEARY, WATERBURY, CT (US); ANTHONY J. DIMAIO, WOODBURY, CT (US)

Correspondence Address: RAYMOND D. THOMPSON, UNIROYAL CHEMICAL COMPANY INC, WORLD HEADQUARTERS, MIDDLEBURY, CT, 06749

(21) Appl. No.: 09/138,926

(22) Filed: Aug. 24, 1998

(51) Int. Cl. B32B 1/08

(52) U.S. Cl. 428/36.9; 428/35.7

(57) ABSTRACT

Disclosed are low molecular weight polymers formed from monomers comprising ethylene, an alpha-olefin, and optionally a non-conjugated diene, and the use of such polymers to improve the dispersion of reinforcing agents into high molecular weight polymers.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to low molecular weight polymers formed from monomers comprising ethylene, an alpha-olefin, and optionally a non-conjugated diene, and the use of such polymers to improve the dispersion of reinforcing agents into high molecular weight polymers.

2. Description of the Related Art

U.S. Pat. Nos. 5,391,623 and 5,480,941 are directed to the preparation of masterbatch compositions of elastomers with a high concentration of aramid fibers distributed throughout the elastomer.

U.S. Pat. No. 5,527,951 is directed to catalysts for the polymerization of ethylene or the copolymerization of ethylene with alphaolefins and (optionally) nonconjugated polyenes.

U.S. Pat. No. 5,786,504 is directed to certain catalyst promoters in ethylene polymerization processes.

### BRIEF SUMMARY OF THE INVENTION

In one aspect, the present invention relates to a polymer formed from monomers comprising ethylene; CH₂═CHQ wherein Q is C₁-C₈ alkyl; and optionally a non-conjugated polyene; wherein

a) ethylene is present in an amount of from about 67% to about 75% by weight;

b) the non-conjugated polyene is present in an amount of from about 0% to about 30% by weight; and

c) CH₂═CHQ is present in an amount of from about 15% to about 40% by weight;

said polymer having a viscosity average molecular weight of from about 4,000 to about 30,000.

In another aspect, the present invention relates to a composition which comprises the polymer described above, and a reinforcing agent.

In yet another aspect, the present invention relates to a composition which comprises:

a) a polymer formed from monomers comprising ethylene; CH₂═CHQ wherein Q is C₁-C₈ alkyl; and optionally a non-conjugated polyene; wherein

i) ethylene is present in an amount of from about 67% to about 75% by weight;

ii) the polyene is present in an amount of from about 0% to about 30% by weight; and

iii) CH₂═CHQ is present in an amount of from about 15% to about 40% by weight;

said polymer having a viscosity average molecular weight of from about 4,000 to about 30,000;

b) a reinforcing agent; and

c) a high molecular weight polymer.

In yet another aspect, the present invention relates to a moulded article made from the three part composition described immediately above.

### DETAILED DESCRIPTION OF THE INVENTION

The novel low molecular weight polymers of the present invention comprise ethylene, an alphaolefin, and optionally a nonconjugated polyene. Preferred alphaolefins include propylene, butene-1, pentene-1, hexene-1, 3-methylpentene-1, heptene-1 and octene-1, with propylene being most preferred. Preferred nonconjugated polyenes include dienes such as 5-ethylidene-2-norbornene, 1,4-hexadiene and dicyclopentadiene. Preferably, the polyene component is present in an amount of from about 1% to about 20% by weight, more preferably from about 3% to about 15% by weight. Preferably, the alphaolefin component is present in an amount of from about 20% to about 35% by weight, more preferably from about 22% to about 30% by weight. The polymer has a molecular weight (viscosity average) in the range of from about 4,000 to about 30,000, preferably from about 5,000 to about 10,000. Most preferably, the polymer is a solid at room temperature, and yields about 10 mm or less in a needle penetration test as described in Example 1.

The polymerization of the monomers described above may take place in the presence of a catalyst composition which comprises a) a vanadium compound; b) an organo-aluminum compound; and c) a catalyst promoter. Suitable vanadium compounds include vanadium oxytrichloride, vanadium tetrachloride, vanadium acetyl acetonate, vanadyl bis-diethylphosphate, chloro neopentyl vanadate, and the vanadium-containing catalysts described in U.S. Pat. No. 5,527,951, the contents of which are incorporated herein by reference.

The organo-aluminum co-catalyst preferably is an alkyl aluminum or an alkyl aluminum halide, with chlorides being the preferred halides. Preferred alkyl aluminum halides include ethyl aluminum sesquichloride, ethyl aluminum dichloride, diethyl aluminum chloride, and diisobutyl aluminum chloride. Ethyl aluminum sesquichloride and diethyl aluminum chloride are most preferred.

Suitable catalyst promoters include halogenated esters such as butylperchlorocrotonate (BPCC), 4,4,4-trichlorobut-2-eneoate, 2-methyl-4,4,4-trichlorobut-2-eneoate, and other compounds known in the art and described in, for example, U.S. Pat. Nos. 5,527,951 and 5,786,504, the contents of which are incorporated herein by reference, with 2-methyl-4,4,4-trichlorobut-2-eneoate (MBEY) being most preferred.

Other suitable supported and unsupported polymerization catalysts would be readily apparent to one of ordinary skill, and include metallocenes, catalytically active titanium, zirconium, hafnium, chromium, etc.

The monomers may be polymerized in the following manner. The catalyst, co-catalyst, promoter, reaction medium and co-monomers are introduced into a reaction vessel. The molar ratio of the catalyst promoter to the vanadium in the vanadium-containing compound is, preferably, in the range of between about 3:1 and about 80:1, more preferably between about 6:1 and about 64:1, and most preferably between about 12:1 and about 48:1.

The molar ratio of the cocatalyst to catalyst plus catalyst promoter is, preferably, in the range of between about 0.5:1 and about 500:1, more preferably between about 1.5:1 and about 100:1, and most preferably between about 2.5:1 and about 10:1. The catalyst concentration can typically range between about 1×10⁻⁸ and 3×10⁻¹ mole of vanadium per liter of total reaction medium.

The reaction medium is an inert medium such as, e.g., pentane, hexane, heptane, octane, isooctane, decane, benzene, toluene and the like, optionally in combination with liquid alphaolefins. The polymerization reaction is typically conducted in the liquid state at a temperature in the range of between about −25° C. and about 70° C., for a time which can vary from several minutes to several hours or more depending on the specific reaction conditions and materials, typically between about 15 minutes and 3 hours.

The best reinforcement of elastomeric materials occurs when there is a uniform, non-clumped dispersion of the reinforcing agent(s) in the elastomeric material, and the low molecular weight polymers of the present invention may be used to improve the dispersion of various reinforcing fibers into such high molecular weight polymers. According to the present invention, the reinforcing fibers are dispersed with the low molecular weight polymer to form a reinforcing composition. The low melting characteristic of the preferred low molecular weight polymers allows the liquification and wetting of the reinforcing fibers with much facility. The dispersion may be accomplished by means standard in the art, such as by blending on a rubber mill. The amount of reinforcing material which may be dispersed will vary according to the desired application and the nature of the materials used. In general, it is contemplated that blends of up to about 70% by weight of reinforcing agent will be particularly useful, with about 50% being particularly preferred. The reinforcing composition may subsequently be incorporated into a high molecular weight polymer.

The high molecular weight polymers which may be reinforced according to the present invention include both natural rubber and synthetic rubber compounds. Synthetic rubber compounds include, for example, ethylene/alphaolefin/nonconjugated polyene (EPDM) rubbers, styrene/butadiene rubbers, acrylonitrile/butadiene (NBR) rubbers, polychloroprene and sulfur modified polychloroprene, polybutadiene rubbers, etc.

Suitable reinforcing agents according to the present invention include aramid fibers (various lengths, short fibers or pulp; for example as disclosed in U.S. Pat. No. 5,391,623, the contents of which are incorporated herein by reference), cotton, polyesters, fiberglass, etc.

The masterbatch reinforced high molecular weight polymers of the present invention may be processed by well known means into, e.g., various types of reinforced belts, such as v-belts, timing belts, conveyor belts and drive belts; hoses; seals; diaphragms; cables; roll covers; etc., and may contain other conventional additives such as processing aids, antioxidants, antiozonants, etc.

The following non-limiting examples are illustrative of the processes and products of the present invention.

### EXAMPLE 1

Preparation of Low Molecular Weight Polymer

Into a 3 liter stainless steel stirred autoclave (Buchi, Model BEP 280) with jacketed cooling, a dip tube for feeding ethylene, a thermocouple well, pressure gauge and ports for the introduction of hydrogen, propylene, and the catalyst components, were charged 110 grams of liquid propylene and 8.9 g of 5-ethylidene-2-norbornene (ENB). The temperature was set at 60° C. by cooling the jacket with water from a circulating water bath. 25 g of ethylene were then added to the reactor. A solution of 11.1 mmole of ethyl aluminum sesquichloride in 10 ml of hexane from a pressurized bomb was then added to the Buchi followed by enough hydrogen gas to raise the pressure to 270 psig. 43 ml of a hexane solution containing 0.281 mm of vanadium oxytrichloride and 1.31 mmole of MBEY promoter were pumped in continuously over the course of 20 minutes at an inlet pressure of 400 psi. The ensuing exotherm was controlled by the jacket cooling to maintain the temperature of 60° C. The pressure was maintained at 270 psig by feeding ethylene into the Buchi at a rate of 2.4 standard liters per minute to replace the ethylene which was being polymerized. A total of 57.3 g of ethylene was fed in 20 minutes.

The contents of the Buchi were then vented to remove unreacted monomer, and transferred to a two liter agitated pressure vessel (Chemco reactor) containing 200 ml of hexane, 0.1 grams of epoxidized soybean oil and 0.1 g of octadecyl 3,5-di-t-butyl-4-hydroxyhydrocinnamate (Naugard® 76, Uniroyal Chemical Co., Inc., Middlebury, Conn.) to deactivate the catalyst. The hexane/polymer mixture was then washed twice with 400 ml of deoxygenated water, allowing to settle and decant off the aqueous layer each time. The hexane was then removed by distillation leaving a low molecular weight ethylene-propylene-ENB terpolymer with the following characteristics: Mv=8,178; 24.6% propylene; 9.1% ENB; needle penetration (see below): 4.85 mm; yield: 85 g; efficiency: 1,759 grams per gram of catalyst.

Three commercial lots of polymer were prepared substantially as described above, and their properties were determined and listed in Table 1 below.

TABLE 1

| | | | |
|---|---|---|---|
| Lot | 5138/6 | 5138/7 | 5138/8 |
| Plant Data | | | |
| Mv¹ | 7190 | 8210 | 8180 |
| % ethylene | 67 | 71 | 71 |
| % diene | 11 | 12.6 | 13 |
| GPC @ 135° C., ODCB | | | |
| Mw | 42,000 | — | — |
| Mn | 14,000 | — | — |
| Mw/Mn | 3.0 | — | — |
| DSC-variable temp. | | | |
| Tg, ° C. | −46 | −41 | −40 |
| Tm #1, ° C. | 0 | 21 | 18 |
| Tm #2, ° C. | none | 43 | 43 |
| DSC @ 190° C. | | | |
| OIT, min | 4.5 | | |
| Brookfield Vis. | | | |
| (cps, HBT #7) | | | |
| 100° C. | 74,000 | 79,000 | — |
| 60° C. | 670,000 | 408,000 | — |

Note: — means not tested.
¹Mv is a determination of molecular weight by a viscometric method, in which a number average molecular weight is determined by measuring the increase in viscosity of a standard viscosity oil which results when the polymer is dissolved in the oil.

The polymers are pale yellow waxy solids at room temperature.

Needle Penetration Test

Since the hardness of a polymer has some relationship to the crystallinity, molecular weight and tack of the polymer, a needle penetration test can guage the suitability of the low molecular weight polymers of the present invention. The following is an adaptation of ASTM D 1321-95, “Standard Test Method for Needle Penetration of Petroleum Waxes.”

A polymer sample is heated to approximately 100° C. in a specimen container (a glass bottle having a one inch inside diameter and a minimum depth of 1.25 inches, filled to a depth of at least 0.75 inches) for one hour or until the sample is homogeneous and free of air bubbles. The container and contents are cooled to room temperature for 2 hours.

The specimen container is placed on the test shelf of a penetrometer, and the needle is adjusted so that the tip of the needle nearly touches the surface of the specimen. The needle indicator should be in the “zero” position and the total weights of needle and plunger should equal 100±0.15 g. Lock the movable assembly into position.

By means of the fine adjustment knob, the needle tip is brought to just touch the surface of the specimen, watching the reflection of the needle tip as an aid. When in place, the needle shaft is released and held free for 5±0.1 seconds, then re-locked. The indicator shaft is gently depressed until it is stopped by the needle shaft, and the penetration is read from the indicator scale.

The needle is cleaned with hexane to remove any adhering polymer, and the test is repeated three more times, repositioning the needle to a new location each time. The mean of the four penetrations is reported to the nearest 0.1 mm.

### EXAMPLE 2

Blending of Low Molecular Weight Polymer with Aramid Fibers

A Brabender internal mixer was warmed to 80° C., and the desired amount of the polymer from Example 1 was added. When the polymer melted, the desired amount of aramid fiber (KEVLAR® merge 1F561 short fiber, DuPont, Wilmington, Del.) was added to the melted polymer, the polymer and fibers were mixed for ten minutes at 100 rpm, then allowed to cool and removed. The data for runs A-E are presented below in Table 2. Up to 50% by weight of aramid fibers were blended with the low molecular weight polymer.

TABLE 2

| | A | B | C | D | E |
|---|---|---|---|---|---|
| Low MW | 150 g | 150 g | 150 g | 150 g | 140 g |
| polymer | | | | | |
| aramid | 45 g | 60 g | 75 g | 112.5 g | 140 g |
| fiber | | | | | |
| % fiber | 23% | 28.6% | 33% | 43% | 50% |

### EXAMPLE 3

Triblending of Low Molecular Weight Polymer, Aramid Fiber and High Molecular Weight EPDM

In this example, four different blends of a low molecular weight polymer according to the present invention, aramid fiber, and a high molecular weight EPDM rubber were made. The low molecular weight polymer was added onto a cold 8″ rubber mill. Next, the aramid fiber was added slowly, while increasing the temperature to 150-200° F. The high molecular weight EPDM rubber (Royalene® 521, Uniroyal Chemical Company, Middlebury, Conn.) was added, the mill was cooled down, and the resulting triblend was stripped off. The various compositions are described in Table 3 below.

TABLE 3

| | Low mw polymer | Aramid fiber | EPDM |
|---|---|---|---|
| Blend 1 | 40 g | 40 g | 85 g |
| Blend 2 | 120 g | 40 g | 90 g |
| Blend 3 | 80 g | 40 g | 80 g |
| Blend 4 | 80 g | 40 g | 80 g |

### EXAMPLE 4

In this example, the rate of incorporation into an EPDM rubber of aramid fibers alone, and aramid fibers mixed with a low molecular weight polymer, are compared. A triblend was prepared as described in Example 3, which contained 33% aramid fiber. As a comparison, a 33% aramid fiber/high molecular weight EPDM blend was prepared as in Example 3, except that the low molecular weight polymer was omitted. It took 35 minutes to incorporate the aramid fiber into the high molecular weight EPDM, compared to 16.5 minutes to incorporate the aramid fiber/low molecular weight polymer into the EPDM, a time saving of 18.5 minutes (53%).

### EXAMPLE 5

This example demonstrates a procedure for the dispersion of aramid fiber (100 grams of 1F 538 Kevlar®) into 100 grams of Neoprene GNA with the aid of a low molecular weight polymer (100 grams of Trilene® 77) on a rubber mill according to the present invention.

| Time | Temperature | Comments |
|---|---|---|
| 0 | 75° F. | Start adding Neoprene |
| 3′ | 94° F. | Masticate polymer-no peptizer |
| 6′36″ | 110° F. | Start adding Trilene ® 77 |
| 11′ | | Start adding Kevlar ® slowly |
| 13′30″ | 108° F. | |
| 15′30″ | | Cool, no heat added, continue |
| | | adding Kevlar ® |
| 18′ | 123° F. | Warms up on addition of fiber |
| 19′ | | Finish adding Kevlar ® |
| 21′ | 150° F. | Add heat |
| 23′ | 190° F. | Turn off steam, add cold water |
| 25′ | 140° F. | |
| 27′30″ | 87° F. | Finished, sheet off mill. |

1. A polymer formed from monomers comprising ethylene; CH₂═CHQ wherein Q is C₁-C₈ alkyl; and optionally a non-conjugated polyene; wherein
a) ethylene is present in an amount of from about 67% to about 75% by weight;
b) the non-conjugated polyene is present in an amount of from about 0% to about 30% by weight; and
c) CH₂═CHQ is present in an amount of from about 15% to about 40% by weight;
said polymer having a viscosity average molecular weight of from about 4,000 to about 30,000.

2. The polymer of claim 1, wherein the non-conjugated polyene is selected from the group consisting of 5-ethylidene-2-norbornene, 1,4-hexadiene and dicyclopentadiene.

3. The polymer of claim 2, wherein Q is methyl.

4. The polymer of claim 3, wherein the polyene component is present in an amount of from about 1% to about 20% by weight.

5. The polymer of claim 4, wherein the polyene component is present in an amount of from about 3% to about 15% by weight.

6. The polymer of claim 1, wherein the CH₂═CHQ component is present in an amount of from about 20% to about 35% by weight.

7. The polymer of claim 6, wherein the CH₂═CHQ component is present in an amount of from about 22% to about 30% by weight.

8. The polymer of claim 1, wherein the polymer has a viscosity average molecular weight of from about 5,000 to about 10,000.

9. The polymer of claim 1, wherein the polymer yields about 10 mm or less in a needle penetration test.

10. The polymer of claim 1, wherein said polymer further comprises a reinforcing agent.

11. The polymer of claim 10, wherein the reinforcing agent is selected from the group consisting of aramid fibers, cotton, polyesters, fiberglass, and mixtures thereof.

12. The polymer of claim 11, wherein the reinforcing agent comprises aramid fibers.

13. The polymer of claim 10, wherein the reinforcing agent is present in an amount of up to about 70% by weight.

14. A composition which comprises:
a) a polymer formed from monomers comprising ethylene; CH₂═CHQ wherein Q is C₁-C₈ alkyl; and optionally a non-conjugated polyene; wherein
i) ethylene is present in an amount of from about 67% to about 75% by weight;
ii) the polyene is present in an amount of from about 0% to about 30% by weight; and
iii) CH₂═CHQ is present in an amount of from about 15% to about 40% by weight;
said polymer having a viscosity average molecular weight of from about 4,000 to about 30,000;
b) a reinforcing agent; and
c) a high molecular weight polymer.

15. The composition of claim 14, wherein the non-conjugated polyene is selected from the group consisting of 5-ethylidene-2-norbornene, 1,4-hexadiene and dicyclopentadiene.

16. The composition of claim 15, wherein Q is methyl.

17. The composition of claim 16, wherein the polyene component is present in an amount of from about 1% to about 20% by weight.

18. The composition of claim 17, wherein the polyene component is present in an amount of from about 3% to about 15% by weight.

19. The composition of claim 14, wherein the CH₂═CHQ component is present in an amount of from about 20% to about 35% by weight.

20. The composition of claim 19, wherein the CH₂═CHQ component is present in an amount of from about 22% to about 30% by weight.

21. The composition of claim 14, wherein the polymer of part a) has a viscosity average molecular weight of from about 5,000 to about 10,000.

22. The composition of claim 14, wherein the polymer of part a) yields about 10 mm or less in a needle penetration test.

23. The composition of claim 14, wherein the reinforcing agent is selected from the group consisting of aramid fibers, cotton, polyesters, fiberglass, and mixtures thereof.

24. The composition of claim 23, wherein the reinforcing agent comprises aramid fibers.

25. The composition of claim 14, wherein the high molecular weight polymer is selected from the group consisting of natural rubber and synthetic rubber.

26. The composition of claim 25, wherein the synthetic rubber is selected from the group consisting of is ethylene/alphaolefin/nonconjugated polyene (EPDM) rubbers, styrene/butadiene rubbers, acrylonitrile/butadiene (NBR) rubbers, polychloroprene and sulfur modified polychloroprene, and polybutadiene rubbers.

27. A moulded article made from the composition of claim 14.

28. The article of claim 27, wherein the article is selected from the group consisting of a v-belt, a timing belt, a conveyor belt, a drive belt, a hose, a seal, a diaphragm, a cable and a roll cover.
